(19) United States
(12) Patent Application Publication
(10) Pub. No.: US 2018/0150294 A1
(43) Pub. Date: May 31, 2018

(54) BACKOUT TOOL FOR SOURCE CONTROL SYSTEMS

(71) Applicant: Microsoft Technology Licensing, LLC, Redmond, WA (US)

(72) Inventors: Ryan Patrick Phillips, Bellevue, WA (US); Alexander Whitmore Halfpenny, Seattle, WA (US); Roman Tsegelskyi, Seattle, WA (US)

(73) Assignee: Microsoft Technology Licensing, LLC, Redmond, WA (US)

(21) Appl. No.: 15/382,214

(22) Filed: Dec. 16, 2016

Related U.S. Application Data
(60) Provisional application No. 62/427,755, filed on Nov. 29, 2016.

(51) Int. Cl. G06F 9/44; G06F 9/45

(52) U.S. Cl. CPC G06F 8/71; G06F 8/30; G06F 8/41

(57) ABSTRACT

A system and method for backing out changes via a version control system. One or more changes are made by a developer and committed to a first branch of a repository of the version control system. While validating the changes during a software build, at least one error occurs as a result of the developer's changes. In response to the error, the changes are automatically reverted so that the changes are backed out from the first branch thereby defining a first reversion. A second branch is automatically created in the repository with the first reversion pulled from the first branch without the changes. Then, in response to the error, the changes are automatically reapplied to the first reversion of the second branch of the repository.

### CROSS-REFERENCE TO RELATED APPLICATIONS

The present application claims benefit from U.S. Provisional Application No. 62/427,755, filed Nov. 29, 2016 and having the title “BACKOUT TOOL FOR SOURCE CONTROL SYSTEMS,” which is herein incorporated by reference in its entirety.

### BACKGROUND

When building a particular software system, application, or software component, software developers continually write new source code or change existing source code. Thus, software tools for revision control are essential for the organization of multi-developer projects.

Version or source control systems are used to manage changes to source code over time and can include centralized or distributed source control systems. For example, a source control system allows for reverting files back to a previous state, reverting an entire project back to a previous state, comparing changes over time, and for determining who may have introduced an issue and when, etc.

A distributed source control system provides revision control on a peer-to-peer model. For example, in a distributed source control system each peer's working copy of the source code is a complete source code repository. A distributed source control system may or may not include a central repository on which client computing devices synchronize.

For example, GIT is a free open-source version control system used for software development and other version control tasks. However, it is often necessary to back out a developer's changes when errors occur during a build. Moreover, during a build, several developers may have committed changes to a project that resulted in errors. Therefore, it is often necessary to back out changes created by multiple developers in order to determine what caused the break in the build.

A GIT repository typically includes a tree structure where each commit or submission of changed code creates a new node in the tree. The master is the repository's main branch where the integration or synchronization occurs in the workflow. Duplications of an object under revision control such as source code, may be depicted as one or more break-out or development branches created by developers in order to make changes or modifications. Also, in version control systems, such as GIT®, when changes are merged into the main branch and errors subsequently occur, a new branch such as a development branch is created for the developer in order to fix the errors so that the developer does not try to fix code from the main branch. However, as a result of the errors, the new branch reverts back to the last good copy pulled from the main branch. In other words, the changes the developer committed and merged into the main branch that resulted in one or more errors while being validated during a build are undone and, therefore, not included in the new branch. What is needed is a tool for use with version or source control systems that allows developers to more easily deal with reverted changes.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

To improve revising and backing out of bad changes in association with developers' use of a source control system, the systems, methods, and computer storage media disclosed herein provide, in response to errors, automatic reversion of changes and creation of an additional branch in a repository of the source control system to which the reversion is pulled to, and reapplication of the changes to the reversion in the new branch so that the developer can resolve the error. As a result of the reversion, other developers are permitted to continue development from the main branch without the changes that resulted in the error.

According to one aspect disclosed herein, a computer-implemented method is presented for backing out changes via a version control system as a result of a failed software build. The method disclosed herein includes committing one or more first changes of software to a first branch of a repository of the version control system. The method then includes validating the one or more first changes indicating at least one error as a result of at least one of the first changes. In response to the error, the method then includes automatically reverting the one or more first changes so that the one or more first changes are backed out from the first branch thereby defining a first reversion, automatically creating a second branch in the repository with the first reversion pulled from the first branch without the one or more first changes, and automatically reapplying the one or more first changes to the first reversion of the second branch of the repository. Also, the method may further include committing to the first branch one or more additional changes made in the second branch to the first reversion that has the reapplied one or more first changes and then validating the one or more additional changes to determine whether the at least one error remains. Also, if the error remains or if there is an new error, the method may then further include automatically reverting the one or more additional changes from the first branch so that the one or more additional changes are backed out of the first branch thereby defining a second reversion, automatically creating a third branch in the repository with the second reversion pulled from the first branch without the one or more additional changes, and automatically reapplying the one or more additional changes to the second reversion of the third branch of the repository. The method may also include notifying one or more developers responsible for the one or more first changes of the first reversion with the reapplied one or more first changes in the second branch in order to resolve the error. The method may also include notifying one or more developers responsible for the additional changes of the second reversion with the reapplied one or more additional changes in the third branch in order to resolve errors.

According to another aspect disclosed herein, a source control system for backing out and revising a software developer's failed changes is provided. The source control system includes a source control repository of source code and a compiler for compiling and verifying the functionality of the source code. The source control system also includes an orchestration engine for committing a first change to a first branch of the repository, wherein the compiler validates the first change and indicates an error as a result of the first change, and wherein in response to the error the orchestration engine automatically reverts the first change from the first branch so that the first change is backed out thereby defining a first reversion, automatically creates a second branch in the repository with the first reversion pulled from the first branch without the first change, and automatically reapplies the first change to the first reversion of the second branch of the repository.

According to yet another aspect disclosed herein, a computer readable storage device including instructions is provided. The instructions, when executed by a processor, are operable to perform committing one or more first changes of software to a first branch of a repository of the version control system and validating the one or more first changes. The instructions are also operable to perform indicating at least one error as a result of at least one of the first changes. In response to the error, the instructions perform automatically reverting the one or more first changes from the first branch so that the one or more first changes are backed out thereby defining a first reversion, automatically creating a second branch in the repository with the first reversion pulled from the main branch without the one or more first changes, and automatically reapplying the one or more first changes to the first reversion of the second branch of the repository.

Examples are implemented as a computer process, a computing system, or as an article of manufacture such as a device, computer program product, or computer readable medium. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is an example operating environment having a distributed source control system for managing changes to software and other collections of information according to at least one aspect herein;

FIG. 2 illustrates a prior art workflow within an example distributed source control system;

FIG. 3 illustrates an improved workflow within the distributed source control system of FIG. 1 according to at least one aspect herein;

FIG. 4 illustrates a flowchart showing general stages involved in an example method for backing out changes via the distributed source control system of FIG. 1 according to at least one aspect herein;

FIG. 5 illustrates optional stages to the flowchart of FIG. 4 according to one or more aspects disclosed herein;

FIG. 6 is a block diagram illustrating example physical components of a computing device;

FIGS. 7A and 7B are block diagrams of a mobile computing device; and

FIG. 8 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to a method, system, and computer storage device for revising software such as source code and, in particular, for backing out changes via a source control system as a result of a failed validation during a software build. Version control systems such as a source control system may be a stand-alone application or be embedded in various types of software such as, but not limited to, multi-developer software development, word processors, spreadsheets, collaborative documents, and content management systems.

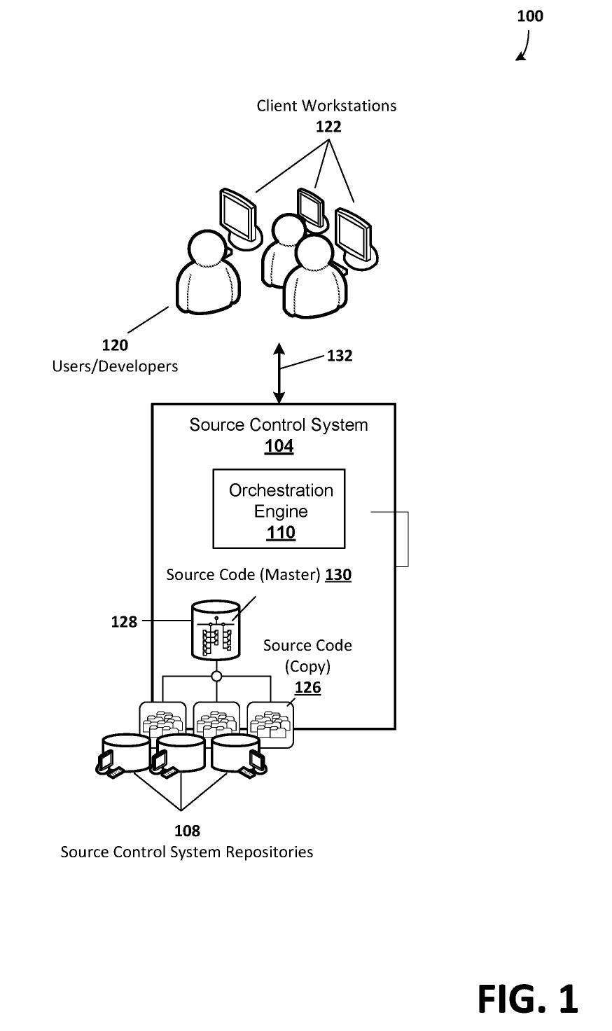

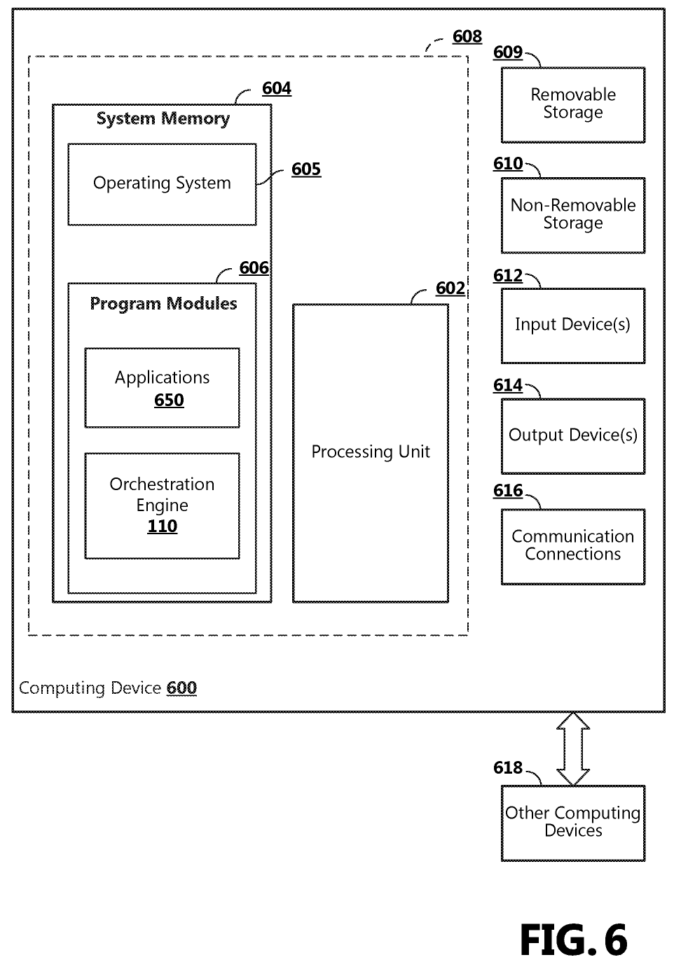

FIG. 1 illustrates an example environment 100 of a source control system 104 corresponding to, for example, a software development project. The example operating environment 100 includes one or more client workstations 122 or client computing devices via which users 120 (e.g., software developers) can use to write and edit software such as source code 130 used to build a particular software system, application, or software component. The client workstations 122 are operative to communicate over a network 132, which may include wired or wireless networking, with a source control system, such as source control system 104, for managing different versions of source code files that are compiled together to create executables that are shipped to customers. The hardware of these computing devices is discussed in greater detail in regard to FIGS. 6, 7A, 7B, and 8.

The source control system 104 is illustrated as a distributed source control system where a plurality of developers 120 each clone a copy 126 of a repository (source control system repositories 108a-n, collectively 108) to his/her client workstation 122. For example, each copy 126 or clone includes all the metadata of the main or master source code 130. The terms “source control system” and “distributed source control system” may be used interchangeably herein. In some aspects of the distributed source control system 104, developers 120 on different client workstations 122 may share edited files directly, obviating the need to transfer files to a centralized location. However, in some other aspects, the distributed source control system 104 includes a centralized remote repository 128 operative to store a remote master or main branch of the source code 130. Some examples of distributed source control systems include MERCURIAL™ (available from the Mercurial Community at https://www.mercurial-scm.org/downloads), GIT® (available from the Software Freedom Conservancy, Inc. of New York, N.Y.), and BAZAAR® (available from Canonical Ltd. of the Isle of Man, UK).

A developer 120 may use a client workstation 122 as part of the distributed source control system 104, for example, to work offline, share files with other client workstations in the distributed source control system 104, and use tools associated with the distributed source control system 104. In some examples, tools associated with the distributed source control system 104 are used to make changes to software such as source code 130 managed by the distributed source control system 104 such as to develop new software features or to fix bugs.

The source control system 104 also includes an orchestration engine 110, which may be part of or separate from the source control system 104, to orchestrate changes to the software. For example, one or more software developers 120 may want to use the source control system 104 in combination with the orchestration engine 110 to commit, check in, submit, write, or merge changes made in a working copy back to a repository of the source control system 104. The repository is where files' current and historical data are stored, often on a server, and which is sometimes referred to as a depot. The orchestration engine 110 also forward integrates changes made in a main branch of a tree structure or hierarchy of the repository of the source control system 104 to one or more development branches. The orchestration engine 110 may also pull or push revisions or changes from one branch of the repository to another. In the event an error or conflict occurs as a result of a change to source code 130, for example, the orchestration engine 110 indicates or identifies that an error has occurred so that the developer 120 may address or resolve the error.

The orchestration engine 110 is further operative to import and commit changes made in one or more development branches of the repository of the source control system 104 to the main branch of the repository. In other words, a development branch may be committed such that the changes in the development branch are merged with the master branch of source code 130.

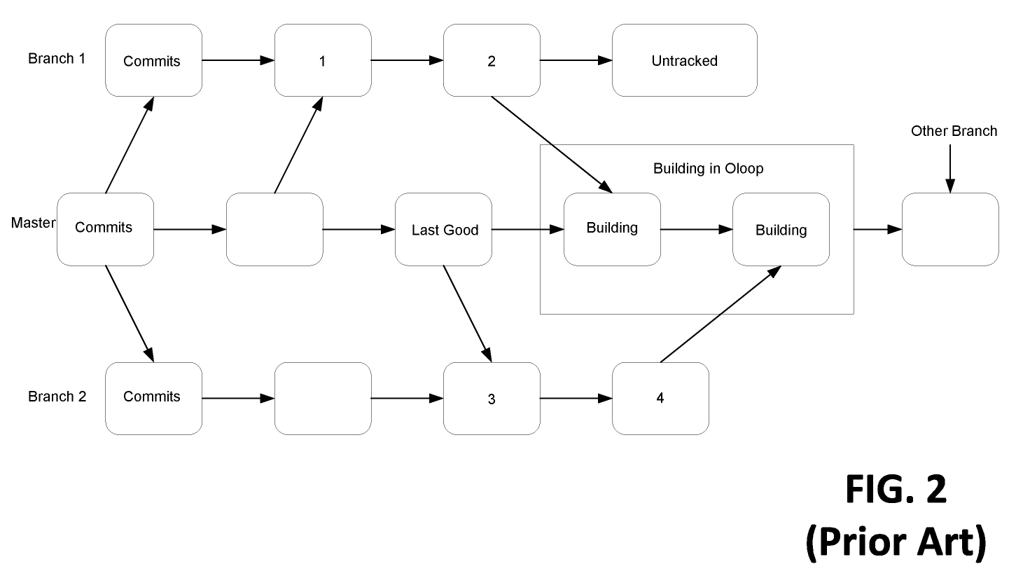

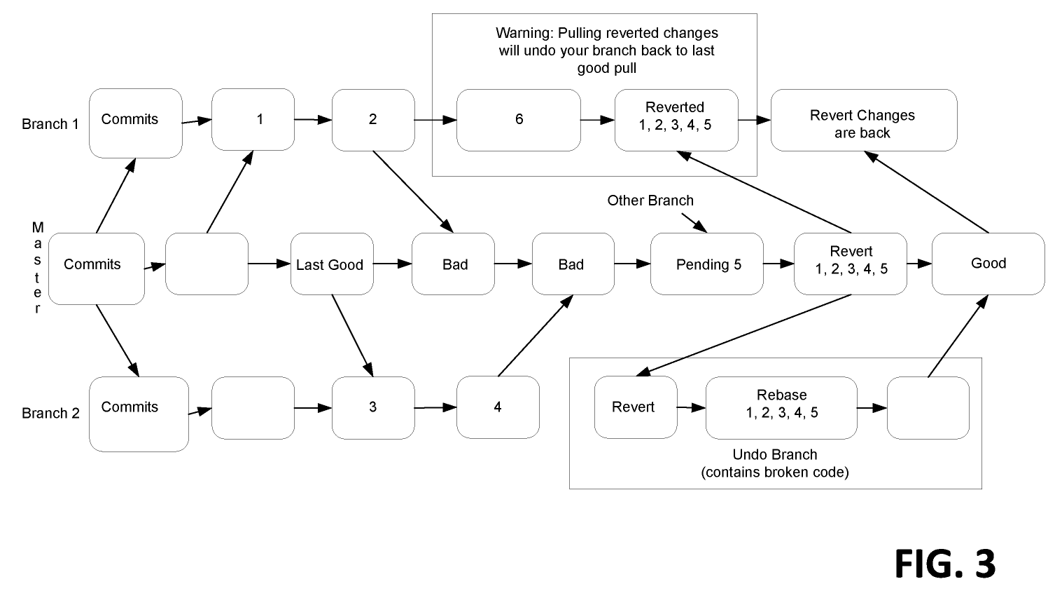

Having described an example operating environment 100 for providing version control via the source control system 104 of FIG. 1, FIGS. 2 and 3 illustrate example flows of data in distributed source control systems. With reference now to the data flow diagram of FIG. 2, a main branch of source code (source code 130) is stored in the repository 128 managed by source control system 104. FIG. 2 also depicts two other branches which are development branches 1 and 2. The first block of the data flow of the main branch is a commit or an import of the source code into the repository. From the first commit of the main branch, copies of the source code can be pushed to each of the development branches as depicted by each of the first commit blocks of the development branches. Following the first commit block of the main branch, updated successive versions of the source code are depicted, for example, by the next two blocks where the third block is labeled as the last good commit to the main branch. In other examples, the main branch may include fewer or more instances or nodes of the revised sources code and, therefore, depict fewer or more blocks in the main branch.

In development branch 1, two consecutive and separate changes are depicted by change blocks 1 and 2 and, in development branch 2, two consecutive and separate changes are depicted by change blocks 3 and 4. A copy of the source code from the main branch is revised to create change block 2 and then the copy of the source code is changed a second time as depicted by the change block 2 in the development branch 1. In regard to development branch 2, a copy of the last good version of the source code in the main branch is pushed to the development branch 2 which is revised to constitute the change block 3. Another change is created in development branch 2 which results in change block 4. Following the changes occurring in change blocks 2 and 4, the developers working in the development branches commit the changes 1-4 for validation during a build.

As depicted in FIG. 2, each of the commits corresponding with change blocks 1-4 may be built in an Oloop. As explained above, if either of the changes 1-4 result in an error, the changes are reverted from the source code of the main branch so that other developers may continue to pull from the main branch good versions of the source code without changes that result in errors. Also, any copies of source code then provided to development branches inconveniently will have the changes backed out.

However, FIG. 3 depicts one aspect of how to back out bad changes in the main branch of a repository but then still receive the previously committed changes in a development branch that had resulted in the error. The flow diagram of FIG. 3 includes the main branch of source code (source code 130) managed by source control system and the two other development branches 1 and 2. FIG. 3 also depicts the commit blocks and the change blocks 1-4 of the development branches 1 and 2. However, FIG. 3 is different from FIG. 2 following the commits of change blocks 2 and 4. The two successive blocks in the main branch of FIG. 3 labeled as “Bad” depict, in particular, the failed validations of the changes 1-4.

FIG. 3 also then depicts in the main branch receiving a commit of a change 5 from another development branch where validation of change 5 remains pending. In the event change 5 results in an error as well, then changes 1, 2, 3, 4, and 5 are reverted as depicted in the main branch so that the source code of the main branch remains free of the set of changes that have resulted in errors. Although one or more, but not all, of the changes 1, 2, 3, 4, and 5 could have themselves been successfully validated in one or more other examples, all of the changes 1, 2, 3, 4, and 5 that were included in the same validation attempt are preferably reverted. In other words, even though each of changes 1, 2, 3, 4, and 5 may not result in errors, all the changes 1, 2, 3, 4, and 5 that are part of the same validation attempt are nevertheless preferably reverted.

Following the block in the main branch depicting the reversion of changes 1, 2, 3, 4, and 5, the orchestration engine 110 creates a new branch from the reversion (without changes 1, 2, 3, 4, and 5) from the main branch which may be referred to as an undo branch. Following the creation of the undo branch with the reversion, changes 1, 2, 3, 4, and 5 are then reapplied to the reversion. Reapplying changes 1, 2, 3, 4, and 5 is depicted in the undo branch by the rebase block where changes 1, 2, 3, 4, and 5 are combined together (rebased). Thus, the new undo branch then includes the broken code corresponding with changes 1, 2, 3, 4, and 5 so that the developers that originally created changes 1, 2, 3, 4, and 5 can utilize the undo branch to revise the source code such as, for example, by making and committing additional changes, as depicted by the last block in the undo branch, in order to eliminate the errors that occurred as a result of attempting to validate changes 1, 2, 3, 4, and 5.

In one or more examples, the main branch may be referred to as the first branch and the undo branch may be referred to as creating a new second branch. Also, the one or more first changes may be referred to as one or more of the changes 1-4 for example. Additional changes made to the first reversion may then include new subsequent changes other than the changes referred to as the first changes. Also, for example, the first reversion may correspond with the source code pulled from the first/main branch without the first changes (such as changes 1-4) after a failed validation. A second reversion may then correspond with the source code pulled from the first branch without the additional changes after a second failed validation.

Then, still referring to FIG. 3, if the committed revisions that the one or more developers 120 made in response to any errors that occurred as a result of any of the changes 1, 2, 3, 4, and 5, are successfully validated, as depicted by the “Good” block at the end of the main branch, the source code of the main branch thereafter would include the revisions that resolved the errors that occurred as a result of one or more of the changes 1, 2, 3, 4, and 5.

Also, still referring to FIG. 3, the development branch 1 also depicts a change block 6 and then pulling from the main branch a reverted copy of the source code (without the previous changes 1, 2, 3, 4, and 5). As noted in FIG. 3, pulling a reversion will undo a development branch back to the last good pull or last good version of the source code from the main branch. In other words, change 6 would be lost as a result of pulling the reversion from the main branch.

However, as also shown at the end of development branch 1, if the committed revisions addressing the errors as a result of the failed validation of changes 1, 2, 3, 4, and 5 are successfully validated as depicted by the “Good” block at the end of the main branch, then the development branch 1 would thereafter include revisions from the undo branch (addressing the errors that occurred from changes 1, 2, 3, 4, and 5) as a result of pulling from the “Good” block depicted at the end of the main branch. Thus, the flow of data in a distributed source control systems may continue as depicted in FIG. 3. For example, one or more additional changes made in the second branch, such as the undo branch, to the first reversion may be committed to the first or main branch for validation.

Thus, if validation of one or more of the additional changes committed from the redo branch fails, the flow of data in a distributed source control systems may continue beyond what is depicted in FIG. 3. In such case, the one or more additional changes are reverted from the first/main branch so that the one or more additional changes are backed out of the first/main branch thereby defining a second reversion. Then, in response to the failed additional changes, a third branch (which may be referred to as a second undo branch) is automatically created in the repository with the second reversion pulled from the first/main branch without the one or more additional changes. Then, also in response to one or more of the additional changes failing validation, the additional changes are automatically reapplied to the second reversion of the third branch (new second undo branch) of the repository. Reapplying the additional changes may be referred to as rebasing and, as explained above, even if less than all of the additional changes fail validation, it is nevertheless preferable that all of the additional changes are backed out to thereby define the second reversion.

Thus, the combination of committed changes 1 and 2 from development branch 1 and committed changes 3 and 4 from development branch 2 constitutes committing one or more first changes (such as changes 1-4) of software to a first branch (the main branch) of a repository of the version control system where two or more developers 120 commit these multiple changes to the first branch that result in indicating multiple errors. The two or more developers 120 that created the multiple changes from the two different branches then utilize a newly created second branch, such as the undo branch, to change the first reversion that has the reapplied first changes (in this case, changes 1-4) in order to correct the multiple errors. Also, other developers 120 are permitted to pull from the first branch (the main branch) without the one or more first changes (such as changes 1-4) that resulted in the error as a result of the reversion of the one or more first changes from the first branch.

In one or more aspects, one or more developers 120 responsible for a failed validation of a change, receive a notification, such as by email or text for example, regarding any reversion that occurs as a result of their own failed change or any other change that was part of the same validation attempt. Also, in one or more examples, a developer 120 that committed a good change for validation may receive a notification as a result of some other change by another developer 120 failing because more than one change may be combined when performing a validation. Also, in one or more aspects, a developer 120 may be able to specify a range of changes in order for the orchestration engine 110 to then automatically revert one or more changes within the specified range from the first/main branch.

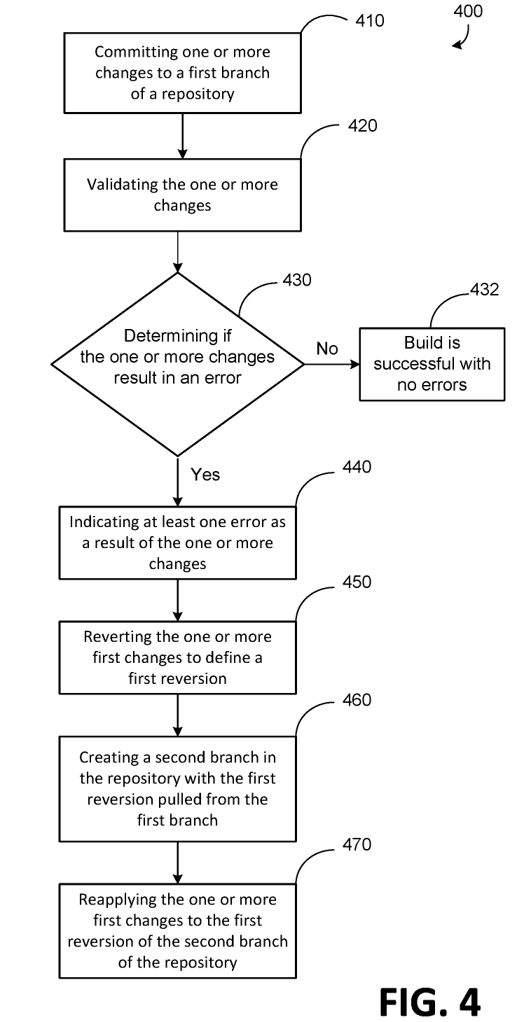

Turning now to FIG. 4, a flowchart is shown depicting the general stages involved in an example method 400 for backing out changes via a version control system as a result of a failed validation such as during a build according to at least one aspect. The method 400 begins at OPERATION 410 by committing one or more first changes of software to a first branch of a repository of the version control system. For example, the first branch may be the main branch and the first changes may be a single change committed from a development branch to the main branch or a set of changes from more than one developer 120 from multiple development branches. The method 400 then proceeds to OPERATION 420 for validating the one or more first changes such as during a software build. The method 400 also includes DECISION BLOCK 430 for determining whether one or more of the changes result in an error during validation. If no errors are found, the method 400 proceeds to OPERATION 432 for indicating the build was successful with no errors.

However, if errors do occur, the method 400 then proceeds from DECISION BLOCK 430 to OPERATION 440 for indicating at least one error occurred as a result of the one or more of the first changes. In response to determining an error, from OPERATION 440, the method 400 then proceeds to OPERATION 450 for automatically reverting the one or more changes so that the one or more first changes are backed out from the first branch and to thereby define a first reversion. Also, in response to the error, the method 400 also includes OPERATION 460 for automatically creating a second branch in the repository with the first reversion pulled from the first branch without the one or more first changes. For example, the second branch may be an undo branch. The method 400 also includes, in response to the error, OPERATION 470 for automatically reapplying the one or more first changes to the first reversion of the second branch of the repository. For example, after the reversion is pushed from the main branch to the new undo branch, all of the changes, where at least one of which resulted in the error, are reapplied in the undo branch so that one or more of the developers 120 responsible for the changes can then resolve the error. Reapplying the collection of the one or more first changes to the first reversion of the second branch of the repository may be referred to as rebasing the one or more first changes to the first reversion of the second branch.

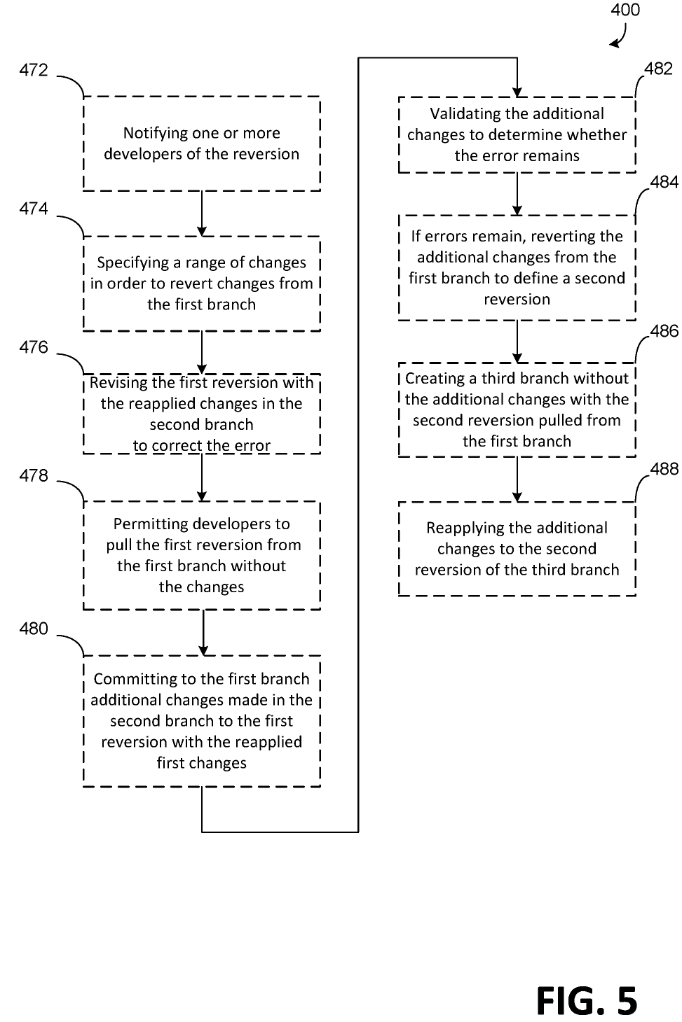

The method 400 may also include one or more of the optional operations as shown in FIG. 5. The method 400 may also include OPERATION 472 for notifying one or more developers 120 responsible for the one or more first changes of the first reversion along with the reapplied one or more first changes in the second branch. The method 400 may also include OPERATION 474 for specifying a range of changes in order to then automatically revert the specified range of the one or more first changes from the first branch.

Also, a developer 120 who created the one or more first changes may revise the first reversion, that has reapplied or rebased one or more first changes, in the second branch in order to correct the error as depicted in optional OPERATION 476. The method 400 may also include OPERATION 478 for permitting other developers 120, who were not responsible for any of the changes that were part of the failed validation, to pull the first reversion from the first/main branch without any of the changes that were part of the failed validation.

Moreover, in another example, two or more developers 120 may commit multiple changes to the first/main branch which could result in indicating multiple errors. In such case, the two or more developers 120 that created the multiple changes utilize the second branch (the undo branch) to change the first reversion having the reapplied first changes in order to correct the multiple errors.

Still referring to FIG. 5, the method 400 may also include OPERATION 480 for committing to the first branch one or more additional changes made in the second branch to the first reversion that has the reapplied one or more first changes and then validating the one or more additional changes to determine whether the at least one error remains. From OPERATION 480, the method 400 may then include OPERATION 482 for validating the additional changes to determine whether the error remains. If the error remains, the method 400 may include: OPERATION 484, for automatically reverting the one or more additional changes from the first branch so that the one or more additional changes are backed out of the first branch thereby defining a second reversion; OPERATION 486, for automatically creating a third branch (such as a second undo branch) in the repository with the second reversion pulled from the first branch without the one or more additional changes; and OPERATION 488, for automatically reapplying the one or more additional changes to the second reversion of the third branch of the repository. The operations of method 400 as depicted in FIGS. 4 and 5 may be performed in a different order or with fewer steps. Also, the method 400 may include one or more, or not any, of the optional operations depicted in FIG. 5.

FIGS. 6-8 and the associated descriptions provide a discussion of a variety of operating environments in which examples are practiced. However, the devices and systems illustrated and discussed with respect to FIGS. 6-8 are for purposes of example and illustration and are not limiting of a vast number of computing device configurations that are utilized for practicing aspects, described herein.

FIG. 6 is a block diagram illustrating physical components (i.e., hardware) of a computing device 600 with which examples of the present disclosure may be practiced. In a basic configuration, the computing device 600 includes at least one processing unit 602 and a system memory 604. According to an aspect, depending on the configuration and type of computing device, the system memory 604 comprises, but is not limited to, volatile storage (e.g., random access memory), non-volatile storage (e.g., read-only memory), flash memory, or any combination of such memories. According to an aspect, the system memory 604 includes an operating system 605 and one or more program modules 606 suitable for running software applications 650. According to an aspect, the system memory 604 includes the orchestration engine 110 of the source control system. The operating system 605, for example, is suitable for controlling the operation of the computing device 600. Furthermore, aspects are practiced in conjunction with a graphics library, other operating systems, or any other application program, and is not limited to any particular application or system. This basic configuration is illustrated in FIG. 6 by those components within a dashed line 608. According to an aspect, the computing device 600 has additional features or functionality. For example, according to an aspect, the computing device 600 includes additional data storage devices (removable and/or non-removable) such as, for example, magnetic disks, optical disks, or tape. Such additional storage is illustrated in FIG. 6 by a removable storage device 609 and a non-removable storage device 610.

As stated above, according to an aspect, a number of program modules and data files are stored in the system memory 604. While executing on the processing unit 602, the program modules 606 (e.g., source control system 104, orchestration engine 110) perform processes including, but not limited to, one or more of the stages of the method 400 illustrated in FIGS. 4 and 5. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 6 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 600 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 600 has one or more input device(s) 612 such as a keyboard, a mouse, a pen, a sound input device, a touch input device, etc. The output device(s) 614 such as a display, speakers, a printer, etc. are also included according to an aspect. The aforementioned devices are examples and others may be used. According to an aspect, the computing device 600 includes one or more communication connections 616 allowing communications with other computing devices 618. Examples of suitable communication connections 616 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. According to an aspect, any such computer storage media is part of the computing device 600. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

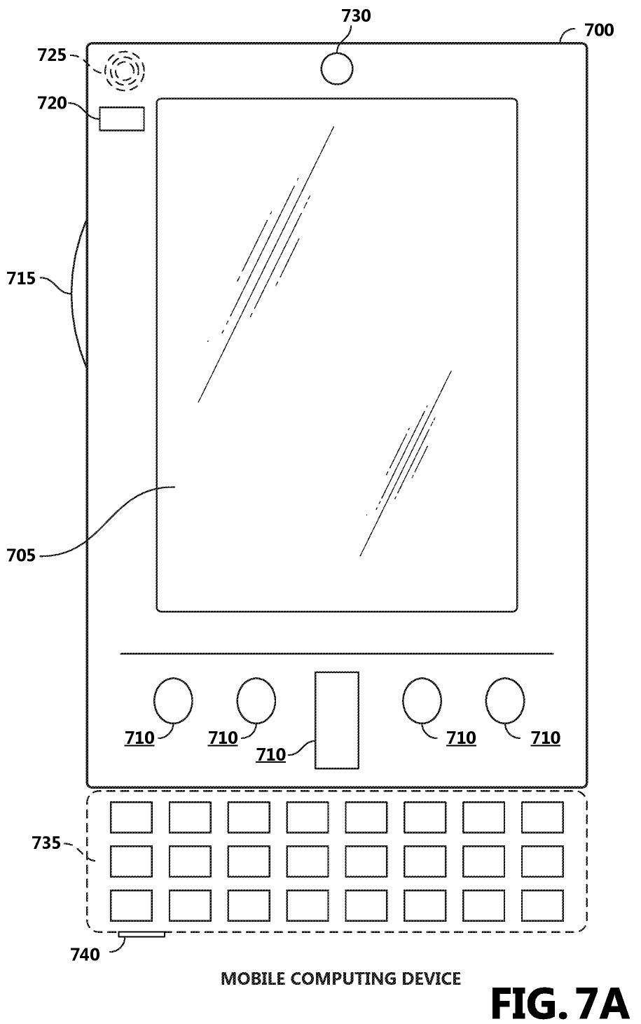

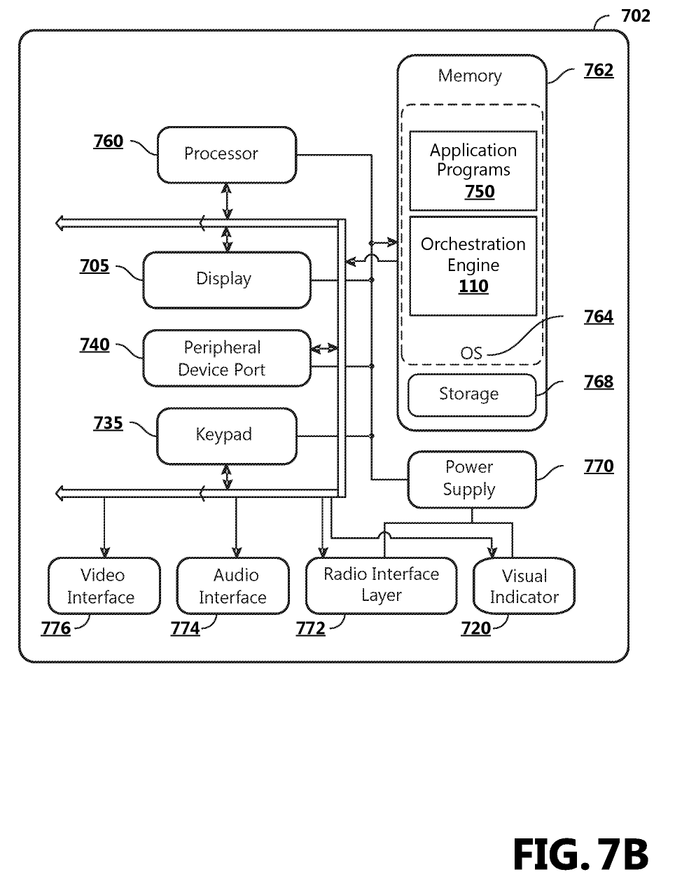

FIGS. 7A and 7B illustrate a mobile computing device 700, for example, a mobile telephone, a smart phone, a tablet personal computer, a laptop computer, and the like, with which aspects may be practiced. With reference to FIG. 7A, an example of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. According to an aspect, the display 705 of the mobile computing device 700 functions as an input device (e.g., a touch screen display). If included, an optional side input element 715 allows further user input. According to an aspect, the side input element 715 is a rotary switch, a button, or any other type of manual input element. In alternative examples, mobile computing device 700 incorporates more or less input elements. For example, the display 705 may not be a touch screen in some examples. In alternative examples, the mobile computing device 700 is a portable phone system, such as a cellular phone. According to an aspect, the mobile computing device 700 includes an optional keypad 735. According to an aspect, the optional keypad 735 is a physical keypad. According to another aspect, the optional keypad 735 is a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 700 incorporates peripheral device port 740, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 incorporates a system (i.e., an architecture) 702 to implement some examples. In one example, the system 702 is implemented as a “smart phone” capable of running one or more applications (e.g., browser, e-mail, calendaring, contact managers, messaging clients, games, and media clients/players). In some examples, the system 702 is integrated as a computing device, such as an integrated personal digital assistant (PDA) and wireless phone.

According to an aspect, one or more application programs 750 are loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. According to an aspect, the orchestration engine 110 is loaded into memory 762. The system 702 also includes a non-volatile storage area 768 within the memory 762. The non-volatile storage area 768 is used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

According to an aspect, the system 702 has a power supply 770, which is implemented as one or more batteries. According to an aspect, the power supply 770 further includes an external power source, such as an AC adapter or a powered docking cradle that supplements or recharges the batteries.

According to an aspect, the system 702 includes a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

According to an aspect, the visual indicator 720 is used to provide visual notifications and/or an audio interface 774 is used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. According to an aspect, the system 702 further includes a video interface 776 that enables an operation of an on-board camera 730 to record still images, video stream, and the like.

According to an aspect, a mobile computing device 700 implementing the system 702 has additional features or functionality. For example, the mobile computing device 700 includes additional data storage devices (removable and/or non-removable) such as, magnetic disks, optical disks, or tape. Such additional storage is illustrated in FIG. 7B by the non-volatile storage area 768.

According to an aspect, data/information generated or captured by the mobile computing device 700 and stored via the system 702 is stored locally on the mobile computing device 700, as described above. According to another aspect, the data is stored on any number of storage media that is accessible by the device via the radio 772 or via a wired connection between the mobile computing device 700 and a separate computing device associated with the mobile computing device 700, for example, a server computer in a distributed computing network, such as the Internet. As should be appreciated such data/information is accessible via the mobile computing device 700 via the radio 772 or via a distributed computing network. Similarly, according to an aspect, such data/information is readily transferred between computing devices for storage and use according to well-known data/information transfer and storage means, including electronic mail and collaborative data/information sharing systems.

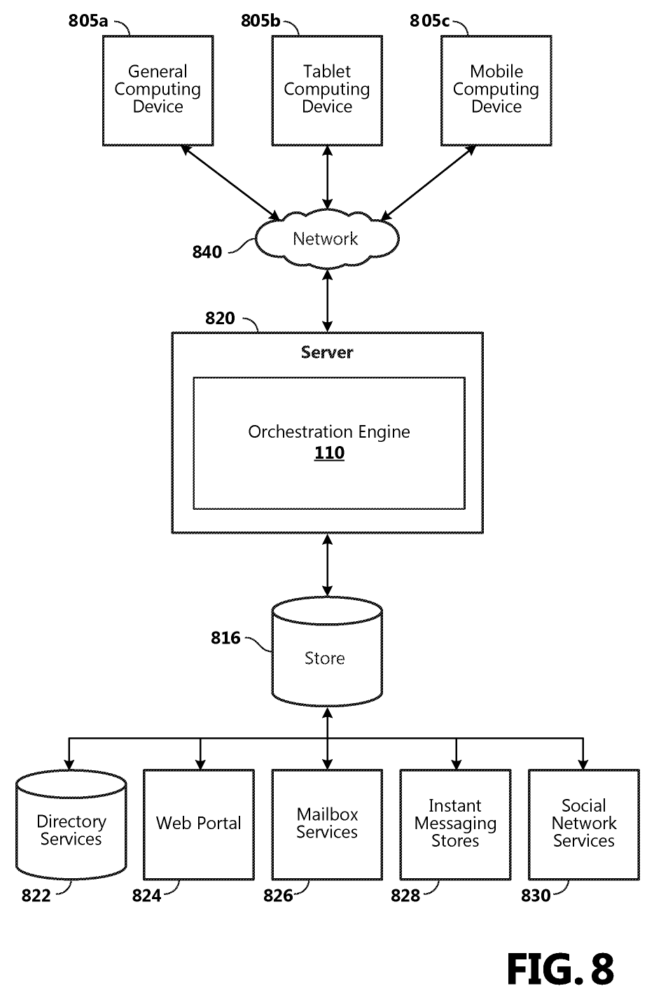

FIG. 8 illustrates one example of the architecture of a system for backing out changes via a version control system as described above. Content developed, interacted with, or edited in association with the orchestration engine 110 is enabled to be stored in different communication channels or other storage types. For example, various documents may be stored using a directory service 822, a web portal 824, a mailbox service 826, an instant messaging store 828, or a social networking site 830. The orchestration engine 110 is operative to use any of these types of systems or the like for managing version control as part of a source control system as described herein. According to an aspect, a server 820 provides the orchestration engine 110 to clients 805a, 805b, 805c. As one example, the server 820 is a web server providing the orchestration engine 110 over the web. The server 820 provides the orchestration engine 110 over the web to clients 805 through a network 840. By way of example, the client computing device is implemented and embodied in a personal computer 805a, a tablet computing device 805b or a mobile computing device 805c (e.g., a smart phone), or other computing device. Any of these examples of the client computing device are operable to obtain content from the store 816.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for backing out changes via a version control system as a result of a failed software build, comprising:
committing one or more first changes of software to a first branch of a repository of the version control system;
validating the one or more first changes;
indicating at least one error as a result of at least one of the first changes; and
in response to the error,
automatically reverting the one or more first changes so that the one or more first changes are backed out from the first branch thereby defining a first reversion;
automatically creating a second branch in the repository with the first reversion pulled from the first branch without the one or more first changes; and
automatically reapplying the one or more first changes to the first reversion of the second branch of the repository.

2. The computer-implemented method of claim 1, wherein reapplying the one or more first changes to the first reversion of the second branch of the repository comprises rebasing the one or more first changes to the first reversion of the second branch.

3. The computer-implemented method of claim 1, further comprising a developer that created the one or more first changes revising the first reversion having the reapplied one or more first changes in the second branch in order to correct the error.

4. The computer-implemented method of claim 1, wherein committing one or more first changes of software to a first branch of a repository of the version control system comprises two or more developers committing multiple changes to the first branch and wherein indicating at least one error as a result of at least one of the first changes comprises indicating multiple errors and the two or more developers that created the multiple changes utilize the second branch to change the first reversion having the reapplied first changes in order to correct the multiple errors.

5. The computer-implemented method of claim 1, further comprising permitting developers to pull from the first branch without the one or more first changes that resulted in the error as a result of the reversion of the one or more first changes from the first branch.

6. The computer-implemented method of claim 1, wherein the version control system is a distributed source control system (DSCS), the first branch is a main branch of a tree structure of the DSCS, and the software is source code.

7. The computer-implemented method of claim 1, further comprising committing to the first branch one or more additional changes made in the second branch to the first reversion that has the reapplied one or more first changes and validating the one or more additional changes to determine whether the at least one error remains.

8. The computer-implemented method of claim 7, further comprising automatically reverting the one or more additional changes from the first branch so that the one or more additional changes are backed out of the first branch thereby defining a second reversion, automatically creating a third branch in the repository with the second reversion pulled from the first branch without the one or more additional changes, and automatically reapplying the one or more additional changes to the second reversion of the third branch of the repository.

9. The computer-implemented method of claim 8, wherein reapplying the one or more first changes to the first reversion of the second branch of the repository comprises rebasing the one or more first changes to the first reversion of the second branch, and reapplying the one or more additional changes to the second reversion of the third branch of the repository comprises rebasing the one or more additional changes to the second reversion of the third branch.

10. The computer-implemented method of claim 1, further comprising notifying one or more developers responsible for the one or more first changes of the first reversion with the reapplied one or more first changes in the second branch.

11. The computer-implemented method of claim 1, further comprising specifying a range of changes in order to automatically revert the one or more first changes from the first branch.

12. A source control system for backing out and revising a software developer's failed changes, the system comprising:
a source control repository of source code;
a compiler for compiling and verifying the functionality of the source code; and
an orchestration engine for committing a first change to a first branch of the repository, wherein the compiler validates the first change and indicates an error as a result of the first change, and wherein in response to the error the orchestration engine automatically reverts the first change from the first branch so that the first change is backed out thereby defining a first reversion, automatically creates a second branch in the repository with the first reversion pulled from the first branch without the first change, and automatically reapplies the first change to the first reversion of the second branch of the repository.

13. The source control system of claim 12, wherein the first change comprises multiple changes and wherein reapplying the first change to the first reversion of the second branch of the repository comprises rebasing the multiple changes of the first change to the first reversion of the second branch.

14. The source control system of claim 12, further comprising a developer that created the first change revising the first reversion having the reapplied first change in the second branch in order to correct the error.

15. The source control system of claim 12, wherein committing the first change of software to a first branch of a repository of the version control system comprises two or more developers committing multiple changes to the first branch and wherein indicating at least one error as a result of the first change comprises indicating multiple errors and the two or more developers that created the multiple changes utilize the second branch to change the first reversion having the reapplied multiple changes in order to correct the multiple errors.

16. The source control system of claim 12, wherein the source control system is a distributed source control system (DSCS), the first branch is a main branch of a tree structure of the DSCS, and the software is source code.

17. The source control system of claim 12, further comprising the orchestration engine committing to the first branch one or more additional changes made in the second branch to the first reversion that has the reapplied one or more first changes and the compiler validating the one or more additional changes to determine whether the at least one error remains.

18. The source control system of claim 17, further comprising the orchestration engine automatically reverting the one or more additional changes from the first branch so that the one or more additional changes are backed out of the first branch thereby defining a second reversion, automatically creating a third branch in the repository with the second reversion pulled from the first branch without the one or more additional changes, and automatically reapplying the one or more additional changes to the second reversion of the third branch of the repository.

19. The source control system of claim 12, further comprising notifying one or more developers responsible for the one or more first changes of the first reversion with the reapplied one or more first changes in the second branch.

20. A computer readable storage device including instructions, which when executed by a processor are operable to perform the steps comprising:
committing one or more first changes of software to a first branch of a repository of the version control system;
validating the one or more first changes;
indicating at least one error as a result of at least one of the first changes; and
in response to the error,
automatically reverting the one or more first changes from the first branch so that the one or more first changes are backed out thereby defining a first reversion;
automatically creating a second branch in the repository with the first reversion pulled from the main branch without the one or more first changes; and
automatically reapplying the one or more first changes to the first reversion of the second branch of the repository.
